(19) United States
(12) Patent Application Publication
(10) Pub. No.: US 2015/0294332 A1
(43) Pub. Date: Oct. 15, 2015

(54) SALES PROCESS REVIEW PLATFORM

(71) Applicant: Michael X. Burns, Marina del Rey, CA (US)

(72) Inventor: Michael X. Burns, Marina del Rey, CA (US)

(21) Appl. No.: 14/687,898

(22) Filed: Apr. 15, 2015

Related U.S. Application Data
(60) Provisional application No. 61/980,043, filed on Apr. 15, 2014.

(51) Int. Cl. G06Q 30/02

(52) U.S. Cl. CPC G06Q 30/0202

(57) ABSTRACT

Apparatuses, systems, methods, and computer program products are disclosed for a sales process review platform. A review module may receive review data from a plurality of users for a sales process of a business entity or the like. An interface module may provide access to received review data. A forecast module may predict a closing date for a sales process with a business entity for a different user. An anonymity module may anonymize review data so that the review data is not associated with an identity of a user. A score module may provide a score to a user based on received review data. A score may be associated with an identity of a user.

### CROSS-REFERENCES TO RELATED APPLICATIONS

This application claims the benefit of U.S. Provisional Patent Application Number 61/980,043 entitled “SALES PROCESS REVIEW PLATFORM” and filed on Apr. 15, 2014 for Michael X. Burns, which is incorporated herein by reference.

### FIELD

This invention relates to sales processes and more particularly relates to a platform for salesperson reviews and forecasts for sales processes.

### BACKGROUND

In the sales industry, analysis of historical data has traditionally been limited. A salesperson may have access to their own records, or those of their employer, but no access to the experiences and records of others. Salespeople may be hesitant to share sales data due to a fear of losing a competitive advantage, due to a non-disclosure agreement (NDA), or the like.

Further, salespeople may be expected to make forecasts indicating timelines, sales amounts, or the like. Such forecasts are typically inaccurate guesses, based on an individual's own experience. A forecast may be even more difficult for a new salesperson with little or no experience with a specific customer or client.

### SUMMARY

Methods are presented for a sales process review platform. In one embodiment, a method includes anonymizing review data received from a plurality of users for a sales process of a business entity so that the review data is not associated with identities of the plurality of users. A method, in a further embodiment, includes predicting a closing date for a sales process with a business entity for a different user based on review data. In certain embodiments, a method includes providing scores to a plurality of users based on received review data, the scores associated with identities of the plurality of users. A method, in one embodiment, includes providing a different user with access to review data without associating the review data with identities of a plurality of users. In certain embodiments, a method includes determining one or more recommended actions for a different user to complete a sales process by a predicted closing date based on review data. In a further embodiment, a method includes providing a predicted closing date and one or more recommended actions to a different user.

Apparatuses are presented for a sales process review platform. In one embodiment, a review module receives review data from a plurality of users for a sales process of a business entity. A forecast module, in certain embodiments, predicts a closing date for a sales process with a business entity for a different user. In a further embodiment, an interface module provides a different user with access to at least a portion of received review data and/or to a predicted closing date.

Other apparatuses are presented for a sales process review platform. In one embodiment, a review module receives review data from a user. An anonymity module, in a further embodiment, anonymizes received review data so that the review data is not associated with an identity of a user. In certain embodiments, a score module provides a score to a user based on received review data. A score, in one embodiment, is associated with an identity of a user.

Review data, in one embodiment, includes a duration of a negotiation stage, a legal review stage, a signature collection stage, and/or an end user license agreement (EULA) stage of a sales process of a business entity. A forecast module, in certain embodiments, receives, from a different user, an indicator of a current stage of the different user in a sales process of a business entity and predicts a closing date for the sales process based on review data and/or on the received indicator.

A review module, in certain embodiments, automatically determines a title of a review comprising review data based on the review data. A review module, in a further embodiment, scans review data for a repeated word and/or a repeated phrase and determines a title that includes the repeated word and/or the repeated phrase. In one embodiment, a review module monitors an amount of time a user spends composing different portions of review data and bases a title on a portion of the review data that the user spends the most time composing.

A roadmap module, in one embodiment, determines one or more recommended actions for a different user to complete a sales process by a predicted closing date based on review data. Review data, in certain embodiments, includes a description of one or more recommended actions from one or more of a plurality of users.

A company portal module, in one embodiment, receives, from a business entity, sales process data associated with a sales process of the business entity. A forecast module, in certain embodiments, predicts a closing date for a sales process based on review data and/or sales process data. A company portal module, in a further embodiment, receives a response from a business entity to review data from one or more users. An interface module, in certain embodiments, provides a plurality of different users with access to a response from a business entity, to review data, and/or to one or more scores (e.g., without associating an identity of a user with the review data).

An apparatus, in certain embodiments, comprises a mobile computing device. A mobile computing device, in various embodiments, may comprise at least a portion of a review module, an anonymity module, and/or a score module. An anonymity module, in one embodiment, anonymizes received review data on a mobile computing device prior to sending the anonymized review data to a server so that an identity of the user is not associated with the review data on the server. A review module, in one embodiment, automatically collects at least a portion of review data from user data stored on a mobile computing device, such as a contact entry and/or a calendar event. A mobile computing device, in certain embodiments, includes one or more sensors. A review module, in one embodiment, receives at least a portion of review data from one or more sensors of a mobile computing device.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for a sales process review platform;

FIG. 2 is a schematic block diagram illustrating one embodiment of a sales process review module;

FIG. 3 is a schematic flow chart diagram illustrating one embodiment of a method for a sales process review platform; and

FIG. 4 is a schematic block diagram illustrating another embodiment of a method for a sales process review platform.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

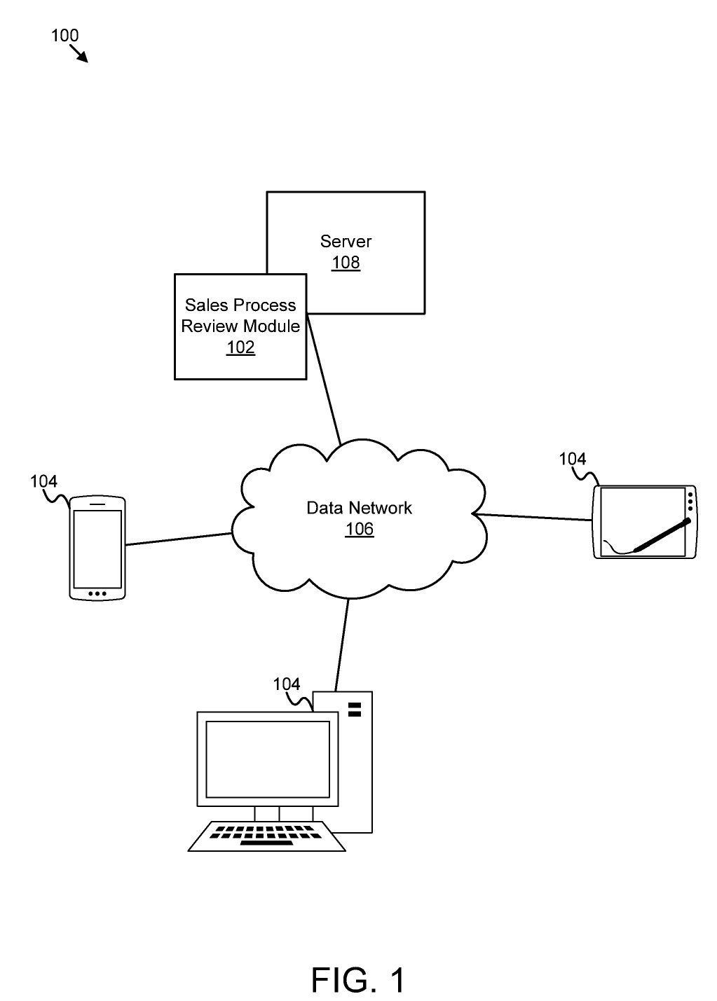

FIG. 1 depicts one embodiment of a system 100 for a sales process review platform. The system 100, in the depicted embodiment, includes a sales process review module 102, a server 108, a data network 106, and one or more clients 104. In the depicted embodiment, the server 108 may deliver website content, application content, or the like of the sales process review module 102, such as web pages, scripts, files, audio, video, or the like to one or more clients 104 and/or users over a data network 106. In one embodiment, a client 104 may include a device capable of receiving and/or displaying data, content, or the like from the data network 106 for a user, sending data from a user over the data network 106, or the like. For example, in some embodiments, clients 104 may include devices such as a desktop computer, a laptop computer, a tablet, a smartphone or other mobile computing device, or another device with a memory and a processor.

The server 108, in certain embodiments, may comprise a server or another computing device (e.g., a device comprising a memory and a processor) capable of delivering data/content to a client 104 over the data network 106. For example, in some embodiments, a server 108 may include a standalone server, a dedicated server, a virtual server, a blade server, a cluster of servers, a web server, or another network enabled device comprising a memory and a processor. In one embodiment, the data network 106 connecting the server 108 to the clients 104 may be the Internet. In a further embodiment, the data network 106 may include another type of network, such as an intranet network, a local area network (LAN), a wide area network (WAN), or the like.

In general, the sales process review module 102 operates with the server 108 to receive reviews from salespeople or other users (e.g., clients 104) on the sales processes of one or more companies. The sales process review module 102 may provide anonymity for users who submit reviews while still providing an incentive to users for submitting reviews. The sales process review module 102, in certain embodiments, may determine and provide a forecast and/or roadmap for a sales process to a user, based on data the sales process review module 102 aggregates from multiple users. The sales process review module 102 may provide insight into a company's sales process, for new salespeople or other salespeople that have never done business with and/or closed a deal with the company, based on anonymized, aggregated input from multiple salespeople. In a further embodiment, the sales process review module 102 may provide a portal for companies to receive feedback on their sales processes, manage their reputations, or the like.

The sales process review module 102, in one embodiment, may provide a business review website for salespeople or other users to share and collaborate about their experiences with their customers, prospects, or other companies. The sales process review module 102 may pull back the curtain to highlight and/or expose purchasing practices of one or more customers or other companies, good or bad. The sales process review module 102, in certain embodiments, may create a greater transparency allowing salespeople and their customers to engage in a real and productive dialogue, in order to work together towards a common goal or simply part ways.

A salesperson or other user may be expected by an executive, manager, supervisor, or the like to provide periodic (e.g., weekly, monthly, quarterly, yearly, occasional) sales forecasts. Rather than simply guessing or estimating sales for a forecast, based on the user's own experience, the sales process review module 102 may provide the user a more accurate forecast, based on reviews or other statistical data input by other users and intelligently processed and aggregated.

In one embodiment, the sales process review module 102 may operate as part of the server 108. In another embodiment, the sales process review module 102 may operate on another computer or server in communication with the server 108 over a local bus or the data network 106. In a further embodiment, the sales process review module 102 may operate in communication with multiple servers 108. In one embodiment, the sales process review module 102 may comprise a user application installed on and/or executing on one or more client devices 104 in communication with the server 108. For example, in embodiments where a client 104 comprises a tablet, smartphone, or other mobile computing device, a portion of the sales process review module 102 installed on and/or executing on the server 108 may cooperate and/or communicate with a portion of the sales process review module 102 installed as a mobile application on the client 104. In other embodiments, a client 104 device, mobile or otherwise, may access and interact with the sales process review module 102 and/or the server 108 using a web browser, without a dedicated application.

In one embodiment, where at least a portion of the sales process review module 102 is installed and/or executing on a client 104 (e.g., a mobile computing device comprising one or more processors, volatile memory, non-volatile storage, and/or a battery or other mobile power source), the sales process review module 102 may access a sensor (e.g., a geographic location sensor, a camera, a near-field communication sensor (NFC), a Wi-Fi module, a Bluetooth module, a touch screen, a touchpad, or the like), user data, or the like on the client 104 and communicate it to the server 108, use it in a review, or the like. For example, the sales process review module 102 may access a user's contact list (e.g., one or more contact entries comprising contact information for another user and/or for a business entity such as a name, title or position, phone number, email address, mailing address, or the like), one or more calendar events, global positioning system (GPS) location, or the like, to facilitate a review, to collect information for a forecast (e.g., collecting meetings held with a company from a calendar), or the like, directly on a user's cellular telephone or other mobile computing device.

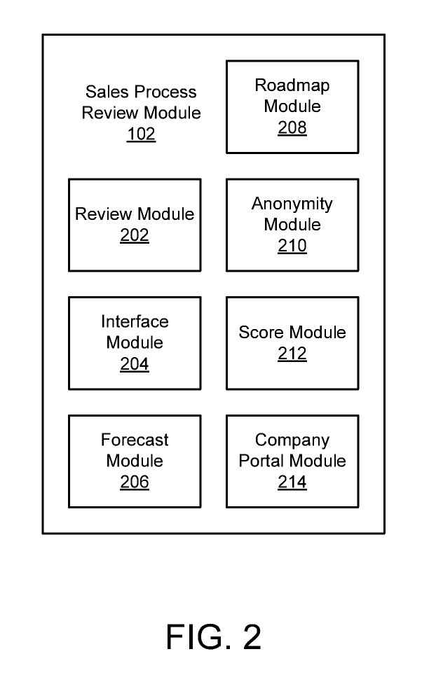

In certain embodiments, the sales process review module 102 executing on a client 104 (e.g., a mobile application) may anonymize data, such as reviews of companies or sales processes, submitted on the client 104, so that a user's identity may not be known to the server 108, to other users or clients 104, and/or to the sales process review module 102 on the client 104 itself In a further embodiment, the sales process review module 102 executing on a client 104 may cooperate with a portion of the sales process review module 102 executing on the server 108 to authenticate or verify the user, and once the user is authenticated and/or verified, subsequent data (e.g., reviews, forecast data, or the like) are anonymized. In this manner, in certain embodiments, the sales process review module 102 may comprise a user application (e.g., a mobile application) through which a user may submit or post an anonymous review online to the server 108, without revealing the user's identity. The sales process review module 102 is described in greater detail below with regard to FIG. 2.

FIG. 2 depicts one embodiment of a sales process review module 102. The sales process review module 102, in certain embodiments, may be substantially similar to the sales process review module 102 described above with regard to FIG. 1. In the depicted embodiment, the sales process review module 102 includes a review module 202, an interface module 204, a forecast module 206, a roadmap module 208, an anonymity module 210, a score module 212, and a company portal module 214. In other embodiments, the sales process review module 102 may comprise a subset of one or more of the depicted modules.

In one embodiment, the review module 202 is configured to receive review data from one or more users or other clients 104, such as salespeople's reviews of sales processes for companies, employees or potential employees' reviews of human resource (HR) departments for companies, or the like. A review and/or review data, as used herein, comprises a description, metric, statistic, or other information regarding an opinion and/or experience of a user with a company or other entity.

The review module 202, in certain embodiments, is configured to receive and store text-based reviews or other review data comprising written descriptions from users (e.g., one or more sentences, paragraphs, or the like). In a further embodiment, the review module 202 may be configured to receive a review or other review data comprising one or more metrics or statistics from a user for a sales process of a company or the like, based on the user's experience with the company. For example, the review module 202 may provide one or more dropdown boxes, check boxes, text boxes, radio buttons, sliders, or other user interface (UI) elements which a user may use to provide one or more metrics or statistics of a review.

In certain embodiments, the review module 202 may access a contact list, one or more calendar events, a GPS location, or the like of a user from a client 104 device, such as a cellular telephone or other mobile computing device, for use in a review, to provide context for a review, to verify that a user is located or has been located at or near a business entity being reviewed, or the like. The review module 202, in one embodiment, may receive data from a user through a web browser of a client 104 device. In a further embodiment, the review module 202 may receive data through a user application executing on a client device 104, such as a desktop application, a mobile application, or the like.

For example, in one embodiment, the review module 202 may receive and save review data comprising one or more metrics or statistics indicating a time period or duration of a step or stage of a sales process of a company, such as a negotiation stage, a legal review stage, a signature collection stage, an end user license agreement (EULA) stage, or the like. In various embodiments, the review module 202 may be configured to receive and save review data comprising one or more metrics or statistics indicating a budget or monetary amount of a sale, a contact person for a sales process, one or more preferences or best practices for a customer or other company, a custom user-defined metric or statistic, or the like.

In certain embodiments, the review module 202 may automatically determine a title for a review based on the information submitted by a user (e.g., based on review data). Salespeople, in certain embodiment, may not be adept at providing a summary or title for a concept, as they may be accustomed to receiving such descriptions from marketing instead of authoring it themselves. For example, the review module 202 may scan submitted review data for one or more repeated words or phrases, one or more predetermined words or phrases, or the like for use in a title; may monitor an amount of time a reviewing user spends writing different words or phrases to use a word or phrase that took the longest to compose, took the least time to compose, or the like; may process submitted reviews using one or more machine learning processes to determine a title; or may otherwise base a title on received review data.

The review module 202, in one embodiment, may store review data in a review repository, such as a database, one or more flat files, or the like, for access by the interface module 204, the forecast module 206, the roadmap module 208, the company portal module 214, or the like described below. By gathering a wide variety of written reviews, statistics, metrics, and/or other information, regarding a sales process for a company or the like, in certain embodiments, the review module 202 may aggregate, average, or otherwise combine the information, providing a more accurate picture or summary of a sales process or the like than any individual user would otherwise have available.

In one embodiment, the interface module 204 is configured to provide users or other clients 104 access to the sales process review module 102, such as reviews, forecasts, roadmaps, user profiles, or the like. The interface module 204, in various embodiments, may be part of, integrated with, in communication with, or otherwise in cooperation with the server 108 or the like to present or otherwise provide information to a user via a client 104. For example, the interface module 204 may comprise or provide one or more static and/or dynamic web pages (e.g., HTML code, PHP code, JavaScript code, other computer executable code, images, video, audio, or the like). At least a portion of the interface module 204, in certain embodiments, may comprise a user application such as a mobile application, a desktop application, or the like executing on a client 104 device, to present data from the server 108 to a user of the client 104 device. In other embodiments, a user may view content from the interface module 204 using a web browser, without a dedicated user application.

The interface module 204, in certain embodiments, may provide access to reviews, review data, or the like by various review attributes. In one embodiment, the interface module 204 may provide access to reviews, review data, or the like by the reviewed company or other entity, providing an alphabetical listing, a search interface, a chronological listing, or the like. In a further embodiment, the interface module 204 may provide access to reviews, review data, or the like by reviewing user, providing an alphabetical listing, a search interface, a chronological listing, or the like. The interface module 204, in one embodiment, provides a search interface allowing users to search for a review and/or review data by one or more review attributes, such as reviewing user, reviewed company or entity, date, reviewing user ranking, or the like.

In one embodiment, the interface module 204 may provide access control or otherwise limit access to reviews, review data, forecasts, roadmaps, or the like, to users that participate by submitting reviews to the review module 202, that have an active subscription, or the like. For example, the interface module 204 may use a predefined ratio of submitted reviews to viewed reviews, such as allowing a user to view a predefined number of reviews, forecasts, roadmaps, or the like per predefined number of reviews submitted (e.g., 1 for 1, 2 for 1, 3 for 1, 4 for 1, 5 for 1, 10 for 1, 20 for 1, or the like). The interface module 204, in further embodiments, may allow users to follow other users, rate or rank other users, message other users, comment on reviews, or the like.

In one embodiment, the forecast module 206 is configured to determine one or more unknown attributes or characteristics of a sales process or other process for a user, based on review data aggregated by the review module 202. For example, the forecast module 206 may predict, estimate, or otherwise determine a date and/or time of closing a deal or sale with a company (e.g., how long a deal will take), a monetary amount of a deal or sale with a company, or the like for a user based on aggregated review data for the company from other users.

The forecast module 206, in one embodiment, provides one or more questions or queries to a user and may use the answers or responses to determine a forecast. For example, the forecast module 206 may ask or query a user which of one or more steps or stages a user has already completed for a deal, a current or estimated forecast for the deal (e.g., using dropdown boxes, checkboxes, radio buttons, sliders, text boxes, or the like). In certain embodiments, the forecast module 206 may access a contact list, one or more calendar events, a GPS location, or the like of a user from a client 104 device, such as a cellular telephone or other mobile computing device, for use in a forecast or the like. The forecast module 206, in one embodiment, may receive data from a user through a web browser of a client 104 device. In a further embodiment, the forecast module 206 may receive data through a user application executing on a client device 104, such as a desktop application, a mobile application, or the like.

The forecast module 206, in various embodiments, may determine a forecast based on an average of submitted review data, a weighted average of submitted review data, a machine learning or artificial intelligence analysis of submitted review data, a statistical analysis of submitted review data, or the like. Because the forecast is based on review data from multiple users, in certain embodiments, the forecast may be more accurate than a forecast based on the experience of a single user, a single company, or the like. The forecast module 206 may provide predictable forecasting based on review data, by using past, historical data associated with deals, a sales process, a company, or the like, the forecast module 206 may accurately forecast a future deal or sales process. In certain embodiments, the forecast module 206 may forecast one or more aspects of a current deal or sales process regardless of and/or independently from one or more metrics of the current deal, such as activity, deal size, or stage.

In one embodiment, the roadmap module 208, in cooperation with the forecast module 206 or the like, may provide one or more suggested, recommended, or predicted steps or actions which a user may take to complete a sale or deal using a company's sales process, based on an analysis of review data submitted by other users for the company. For example, as described above, a user may submit certain data indicating a status of a sales process, such as one or more stages or steps that the user has completed in a sales process of a company.

The roadmap module 208, in one embodiment, may compare the stages or steps that a user has completed with stages or steps submitted for a company by other users, amounts of time that the stages or steps took to complete for other users, or the like, and may determine a roadmap comprising the stages or steps that the user may take to complete the sales process, an estimated or projected amount of time for the stages or steps or for completion of the sales process, or the like. In certain embodiments, the roadmap module 208 may provide a roadmap as part of a forecast of the forecast module 206, may comprise or be integrated with the forecast module 206, may cooperate with the forecast module 206, or the like.

In one embodiment, the anonymity module 210 anonymizes one or more user reviews, providing an anonymous username, pseudonym, avatar, or the like for users. The anonymity module 210, in certain embodiments, allows salespeople to provide public reviews while protecting the salespeople from potential negative repercussions of the reviews. The anonymity module 210, in a further embodiment, may allow a user to optionally use his or her real name, actual identity, or the like, without anonymizing if the user so chooses.

In certain embodiments, at least a portion of the anonymity module 210 may execute on a client 104 (e.g., as a mobile application) to anonymize data, such as reviews of companies or sales processes, submitted on the client 104, so that a user's identity may not be known to the server 108, to other users or clients 104, and/or to the sales process review module 102 on the client 104 itself. In a further embodiment, a portion of the anonymity module 210 executing on a client 104 may cooperate with a portion of the anonymity module 210 executing on the server 108 to authenticate or verify the user, and once the user is authenticated and/or verified, the anonymity module 210 may anonymize subsequent data (e.g., reviews, forecast data, or the like) submitted by the user. In this manner, in certain embodiments, the sales process review module 102 may comprise a user application (e.g., a mobile application) through which a user may submit or post an anonymous review online to the server 108, without revealing the user's identity.

The interface module 204, as described above, may provide access to user profile information, submitted review data, or the like for a user in cooperation with the anonymity module 210, by the user's anonymous username, pseudonym, avatar, or the like. As described below, the anonymity module 210, in certain embodiments, may cooperate with the score module 212 to provide a score, ranking, rating, or other positive incentive to a user for submitting reviews or otherwise participating with the sales process review module 102, which may be associated with the user's real name, actual identity, or the like, while the user and his or her reviews may be anonymous.

In one embodiment, the score module 212 may provide a score, ranking, rating, or other positive incentive to a user for submitting reviews or otherwise participating with the sales process review module 102. A score, ranking, rating, or other positive incentive from the score module 212, in certain embodiments, may be associated with the user's real name, actual identity, or the like, while the user and his or her reviews may be anonymous as described above with regard to the anonymity module 210.

The score module 212 may provide a user a score, update a user's score, or the like based on a number of reviews submitted by the user; ratings or rankings given to the user's reviews by other users; a number of followers, fans, or likes for the user; and/or on another attribute associated with the user. By providing a user a score, ranking, rating, or other positive incentive which the user may optionally associate with the user's real name, actual identity, or the like, while the anonymity module 210, in one embodiment, anonymizes the user's identity, submitted reviews, or the like, a user may review the sales processes of the user's customers or clients without retribution or negative consequences from the customers or clients and receive a positive incentive from the score module 212 (e.g., a score, ranking, rating, badge, or the like) which may be associated with the user's actual identity.

In certain embodiments, the score module 212 may provide a user with an image, computer executable code, a badge, or the like comprising the score, which the user may embed or post on a personal website, a social networking website, a business or company website, or the like, associated with the user's real name and/or actual identity. The score module 212, in one embodiment, may dynamically, automatically, update the embedded score as the user's score changes based on participation (e.g., submitting reviews or the like).

In one embodiment, at least a portion of the score module 212 may execute on a client 104 (e.g., as a mobile application) to determine and/or update a score prior to or in conjunction with the anonymity module 102 anonymizing review data, so that the score module 212 may determine a value of a score and/or a score adjustment based on the review data, while still associating the score and/or the score adjustment with a user's actual identity. In such an embodiment, a portion of the score module 212 executing on a client 104 may send a determined score and/or score adjustment to a portion of the score module 212 executing on the server 108, such that the determined score and/or score adjustment are associated with a user's identity (e.g., the score module 212 may send the score and/or score adjustment with an identifier of the user and/or user's identity), even though the review data itself submitted by the user is not associated with the user and/or the user's identity. For example, in one embodiment, the score module 212 may send the score and/or score adjustment at a separate time (e.g., in a separate transaction, separate message or packet, or the like) than the review module 202 and/or the anonymity module 210 sends the anonymized review data, so that the anonymized review data will not be associated with the user's identity if the transmission were to be intercepted or compromised.

In one embodiment, the company portal module 214 allows a company, a business, or another subject of user reviews to see and/or manage its reputation. The company portal module 214 may provide a portal or other interface, in cooperation with the interface module 204 or the like, to a company, business, or other entity to access user submitted reviews; reply or respond to user submitted reviews; submit or post its own statistics, metrics, or other data related to its sales process or the like (e.g., sales process data, which may be similar to the above described review data, but from a business entity associated with the sales process); or otherwise interact with the sales process review module 102 or the users.

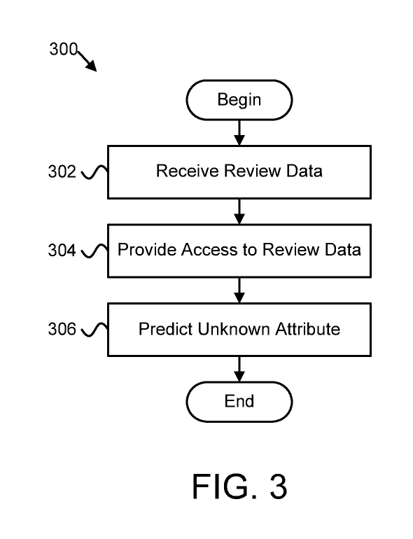

FIG. 3 depicts one embodiment of a method 300 for a sales process review platform. The review module 202 receives 302 review data from a plurality of users, associated with sales processes, HR departments, or the like. The interface module 204 provides 304 access to the aggregated received 302 review data. The forecast module 206 predicts 406 or estimates a closing date or another unknown attribute for a sales process of another user, based on the received 302 review data and the method 300 ends.

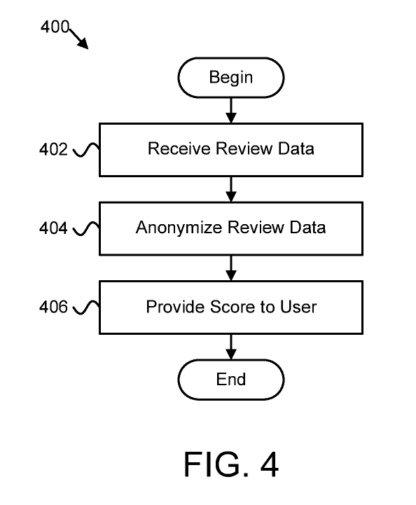

FIG. 4 depicts another embodiment of a method 400 for a sales process review platform. The review module 202 receives 402 review data from a user. The anonymity module 210 anonymizes 404 the received 402 review data so that the review data is not associated with the user's real name, actual identity, or the like. The score module 212 provides 406 a score to the user based on the received 402 review data and the method 400 ends. The score module 212, in one embodiment, may associate the provided 406 score with a real name, actual identity, or the like of the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a review module that receives review data from a plurality of users for a sales process of a business entity;
a forecast module that predicts a closing date for the sales process with the business entity for a different user; and
an interface module that provides the different user with access to at least a portion of the received review data and to the predicted closing date.

2. The apparatus of claim 1, further comprising an anonymity module that anonymizes the received review data so that the review data is not associated with identities of the plurality of users.

3. The apparatus of claim 2, further comprising a score module that provides a score to the user based on the received review data, the score associated with the identity of the user.

4. The apparatus of claim 1, further comprising a roadmap module that determines one or more recommended actions for the different user to complete the sales process by the predicted closing date, the roadmap module determining the one or more recommended actions based on the review data.

5. The apparatus of claim 4, wherein the review data includes a description of the one or more recommended actions from one or more of the plurality of users.

6. The apparatus of claim 1, further comprising a company portal module that receives, from the business entity, sales process data associated with the sales process of the business entity, the forecast module predicting the closing date for the sales process based on the review data and the sales process data.

7. The apparatus of claim 1, further comprising a mobile computing device comprising at least a portion of the review module.

8. The apparatus of claim 7, wherein the review module automatically collects at least a portion of the review data from user data stored on the mobile computing device, the user data comprising one or more of a contact entry and a calendar event.

9. The apparatus of claim 7, wherein the mobile computing device comprises one or more sensors and the review module receives at least a portion of the review data from the one or more sensors.

10. The apparatus of claim 1, wherein the review data comprises a duration of one or more of a negotiation stage, a legal review stage, a signature collection stage, and an end user license agreement (EULA) stage of the sales process of the business entity.

11. The apparatus of claim 10, wherein the forecast module receives an indicator of a current stage of the different user in the sales process of the business entity and predicts the closing date based on the review data and on the received indicator.

12. An apparatus comprising:
a review module that receives review data from a user;
an anonymity module that anonymizes the received review data so that the review data is not associated with an identity of the user; and
a score module that provides a score to the user based on the received review data, the score associated with the identity of the user.

13. The apparatus of claim 12, further comprising a company portal module and an interface module, the review data for a process of a business entity, the company portal module receiving a response from the business entity to the review data from the user, and the interface module providing a plurality of different users with access to the response, to the review data, and to the score without associating the identity of the user with the review data.

14. The apparatus of claim 12, wherein the review module automatically determines a title of a review comprising the review data based on the review data.

15. The apparatus of claim 14, wherein the review module scans the review data for at least one of a repeated word and a repeated phrase and determines the title to include the at least one of the repeated word and the repeated phrase.

16. The apparatus of claim 14, wherein the review module monitors an amount of time the user spends composing different portions of the review data and bases the title on a portion of the review data that the user spends the most time composing.

17. The apparatus of claim 12, further comprising a mobile computing device comprising at least a portion of one or more of the review module, the anonymity module, and the score module, the anonymity module anonymizing the received review data on the mobile computing device prior to sending the anonymized review data to a server such that the identity of the user is not associated with the review data on the server.

18. A method comprising:
anonymizing review data received from a plurality of users for a sales process of a business entity so that the review data is not associated with identities of the plurality of users;
predicting a closing date for a sales process with the business entity for a different user based on the review data; and
providing scores to the plurality of users based on the received review data, the scores associated with the identities of the plurality of users.

19. The method of claim 18, further comprising providing the different user with access to the review data without associating the review data with the identities of the plurality of users.

20. The method of claim 18, further comprising determining one or more recommended actions for the different user to complete the sales process by the predicted closing date based on the review data and providing the predicted closing date and the one or more recommended actions to the different user.
